(19) United States
(12) Patent Application Publication
(10) Pub. No.: US 2017/0025008 A1
(43) Pub. Date: Jan. 26, 2017

(54) COMMUNICATION SYSTEM AND METHOD FOR COMMUNICATING THE AVAILABILITY OF A PARKING SPACE

(71) Applicant: Dura Operating, LLC, Auburn Hills, MI (US)

(72) Inventors: Donald Raymond Gignac, Waterford, MI (US); Aaron Evans Thompson, Grand Blanc, MI (US); Danish Uzair Siddiqui, Rochester Hills, MI (US); Rajashekhar Patil, Ypsilanti, MI (US); Gordon M. Thomas, Beverly Hills, MI (US)

(21) Appl. No.: 15/204,689

(22) Filed: Jul. 7, 2016

Related U.S. Application Data
(60) Provisional application No. 62/194,372, filed on Jul. 20, 2015.

(51) Int. Cl. G08G 1/14

(52) U.S. Cl. CPC G08G 1/143

(57) ABSTRACT

A system and method of using V2V communication to inventory and communicate the availability of a parking space. The method includes capturing and analyzing an image of a parking area to identify the availability and location of a parking space. Real time images of roaming vehicles are also captured and analyzed to identify recently occupied or vacated parking spaces. Available parking spaces are inventoried in a data base. The method further includes a roaming V2V vehicle detecting the availability and location of a parking space and transmitting the information to other V2V vehicles and to the data base to augment the inventory. The database inventory is then transmitted by a roadside unit to a V2V equipped vehicle within the parking area. The V2V vehicle merges the information from the database and other V2V vehicles, and generates a LDM displaying the locations of non-occupied parking spaces contained in the multiple signals.

### CROSS REFERENCE TO RELATED APPLICATIONS

This application claims the benefit of U.S. Provisional Application No. 62/194,372 filed on Jul. 20, 2015, the disclosure of which is incorporated herein by reference in its entirety.

### TECHNICAL FIELD

The invention relates generally to a system and method of using vehicle-to-vehicle (V2V) communication in conjunction with vehicle-to-infrastructure (V2I) communication for inventorying and communicating the availability of a parking space.

### BACKGROUND

The statements in this section merely provide background information related to the present disclosure and may or may not constitute prior art.

In larger parking lots, such as parking lots for airports or shopping malls, it is not uncommon for multiple vehicles to roam the parking lot aisles in search of a parking space, if one is even available. Even if a parking space was found, there is no certainty that the found parking space is the most convenient for the occupant of the vehicle. With dozens of vehicles, if not hundreds during a holiday season or special event, roaming a parking lot searching for available parking space not only creates parking lot congestion resulting in lost productivity, but also increases the amount of fuel consumed and greenhouse gases emitted into the atmosphere.

Parking software applications, or parking apps, leverage commonly available devices, such as portable sensors already installed in cell phones, to crowdsource the locations and movements of people who are parking their cars or about to vacate a parking space, and to communicate the availably of a parking space. These parking apps use the accelerometer and position locators in the cell phones to measure and report behaviors, such as the speed that the holder of the cell phone is traveling. For example, if the cell phone is moving at a slow speed within the same general area, the parking app assumes that the person is driving in a slow moving vehicle looking for a parking space. If a vast number of app users are moving at a slow speed within the same general area, the app may interpret this as the parking lot being full. If the cell phone is moving at a walking-speed and then switched to a speed greater than a fast walk and moves away from the parking area, then that would be interpreted as the person having just entered their vehicle and vacated a parking space.

By analyzing the logistical information from people who have installed the app on their phones, and cross-referencing the parking space data that's readily available on a mapping service, these parking apps can make a fairly well-educated guess about how many open spaces are located near an app user. However, the likelihood of the number of parking spaces available is still an educated guess by the app's algorithm. Another shortcoming is that the parking apps do not provide real time inventory or exact locations of parking spaces within a parking area; therefore, it would still require an amount of circling the parking aisle to locate the supposedly available parking space.

Conventional parking applications are limited by their accuracy in predicting the availability of a parking space, identifying the number of parking spaces, and determining the exact locations of available parking spaces. Therefore, there is a need in the art for a system and method of identifying the availability and locations of parking spaces, inventorying the parking spaces, and communicating the locations of available parking spaces by leveraging and/or minimally modifying commonly available or soon to be commonly available devices.

### SUMMARY

A method of using a V2V communication system on a vehicle for communicating availability of a parking space within a parking area is provided. The method includes the steps of detecting, using a sensor on the vehicle, whether an object is within a parking space as the vehicle drives past the parking space; assigning, using a processor on the vehicle, a status to the parking space of either occupied or non-occupied; determining, using a position locator on the vehicle, the location of the vehicle when the vehicle is adjacent the parking space; assigning, using the processor, a location of the parking space based on the location of the vehicle; and transmitting, using a transmitter on the vehicle, a vehicle data stream containing the status and location of the parking space.

In one aspect, the method further includes the steps of receiving, using a receiver on the vehicle, an incoming data stream containing the status and location of another parking space.

In another aspect, the method further includes the steps of merging, using the processor, the statuses and locations of parking spaces contained in the vehicle data stream and the incoming data stream; and displaying, using a display screen in the vehicle, a local dynamic map of the parking area showing the merged statuses and locations of the parking spaces, and the current location of the vehicle within the parking area.

In another aspect, the incoming data stream is transmitted from another vehicle within the parking area.

In another aspect, the incoming data stream is transmitted from a roadside unit.

In another aspect, the method further includes the steps of capturing, using an infrastructure camera, an image of a portion of the parking area; assigning, using an infrastructure processor, a status and a location for each of the parking spaces within the portion of the parking lot based on the image from the camera; and sending an infrastructure data stream, using the road side unit, containing the status and location for each of the parking spaces within the portion of the parking lot.

In another aspect, the method further includes the steps of capturing, using the infrastructure camera, the real time movement of a roaming vehicle moving into a parking space having the status of non-occupied; and measuring, using the infrastructure processor, the length of time the roaming vehicle remains in the parking space based on the real time movement of the roaming vehicle, and (i) maintaining the status of the parking space as non-occupied if the roaming vehicle continues roaming before a predetermined length of time has elapsed, or (ii) assigning a status to the parking space as occupied if the roaming vehicle remains stationary at or after the predetermined length of time has elapsed.

In another aspect, the camera continues tracking the roaming vehicle if the vehicle leaves the parking space before the predetermined length time has elapsed.

In another aspect, the method further, further includes the steps of capturing, using the infrastructure camera, the real time movement of a vehicle vacating a parking space having the status of occupied; and assigning, using the infrastructure processor, a status of non-occupied to the parking space once the vehicle vacated the parking space.

In another aspect, the method further includes the steps of receiving, by the infrastructure processor, multiple data streams containing statuses and locations of parking spaces; merging, by the infrastructure processor, the statuses and locations of parking spaces contained in the multiple data streams; and transmitting, by the road side unit, a merged data stream containing the merged statuses and locations of parking spaces;

In another aspect, the sources of the multiple data stream are transmitted from multiple vehicles.

Another method of using V2V communication to inventory and communicate an available parking space within a parking area, includes capturing an image of a parking area having at least one parking space; analyzing the image to identify whether a parking space is occupied or non-occupied; assigning a location to a non-occupied parking space; inventorying the location of the non-occupied parking space in a database; transmitting a signal containing the location of the non-occupied parking space; receiving the signal by a V2V equipped vehicle; and processing the signal by the V2V equipped vehicle to display a local dynamic map showing the location of the non-occupied parking space.

In another aspect, the method further includes detecting, by the V2V vehicle, a non-occupied parking space as the V2V vehicle drives past the non-occupied parking space; transmitting a data signal, by the V2V vehicle, containing the location of the non-occupied parking space to an infrastructure processor; and updating, by the infrastructure processor, the inventory of non-occupied parking space in said database.

In another aspect, the method further includes transmitting a vehicle data signal, by the V2V vehicle, containing the location of non-occupied parking space to other V2V vehicles within the parking area.

In another aspect, the method further includes receiving multiple signals, by the V2V vehicle, containing locations of multiple non-occupied parking spaces in overlapping portions of the parking area; merging, by a processor on board the V2V vehicle, overlapping portions of the parking area to generate a local dynamic map displaying the total locations of non-occupied parking spaces contained in the multiple signals.

In another aspect, the method further includes capturing the real time movement of a vehicle vacating an occupied parking space and assigning a status to the parking space as non-occupied once the vehicle vacated the occupied parking space.

In another aspect, the method further includes measuring the length of time after a roaming vehicle entered a parking space having the status of non-occupied; and maintaining, using the infrastructure processor, the status of the parking space as non-occupied if the roaming vehicle continues roaming before a predetermined length of time has elapsed, or assigning, using the infrastructure processor, a status to the parking space as occupied if the roaming vehicle remains stationary after the predetermined length of time has elapsed.

A system for inventorying and communicating available parking spaces, includes a sensor on a V2V vehicle configured to detect whether an object is within a parking space as the vehicle drives past the parking space; a vehicle locator for identifying the location of the vehicle when the vehicle is adjacent the parking space; a processor configured to assign a status to the parking space of either occupied or non-occupied, and assign a location of the parking space based on the location of the vehicle, and a transmitter for transmitting a vehicle data stream containing the status and location of the parking space.

In another aspect, the system further includes a camera configured to capture an image of a parking area having a parking space; an infrastructure processor configured to analyze the overhead image and assign a status to the parking space as either occupied or non-occupied based on the analysis of the overhead image; a data base configured to inventory the location and status of the parking space; and a road side transmitter configured to transmitting an infrastructure signal containing the status and location of the parking space to the V2V vehicle.

In another aspect, the infrastructure processor is further configured to send an infrastructure signal to display a local dynamic map (LDM) showing the location and status of the parking space within the parking area.

In another aspect, the system further includes an infrastructure receiver configured to receive multiple vehicle data streams containing locations and statuses of parking spaces from multiple V2V vehicle, wherein the infrastructure processor is further configured to merge the information contained in the multiple vehicle data streams to remove overlapping information.

Further aspects, examples, and advantages will become apparent by reference to the following description and appended drawings

### BRIEF DESCRIPTION OF THE DRAWINGS

The above and other aspects will become more apparent and more readily appreciated from the following description of exemplary embodiments, taken in conjunction with the accompanying drawings in which:

FIG. 1 is a perspective view of a parking area having a system for inventorying and communicating available parking spaces;

FIG. 2 is a top view of an exemplary vehicle equipped with V2V communication identifying a non-occupied parking space;

FIG. 3 is a perspective view into occupied and non-occupied parking spaces;

FIG. 4 is view of a dashboard of a V2V communication equipped vehicle having a monitor displaying a local dynamic map showing the locations and status of parking spaces; and

FIG. 5 is a general flowchart illustrating a method of using vehicle-to-vehicle (V2V) communication and vehicle-to-infrastructure (V2I) communication for inventorying and communicating the availability of a parking space.

### DESCRIPTION

The following description is merely exemplary in nature and is not intended to limit the present disclosure, applications, or uses.

In general, a system and method of using V2V communication to inventory and communicate the availability of a parking space is provided. The method includes capturing and analyzing an image of a parking area to inventory the availability and location of a parking space. Real time images may be captured to identify a recently occupied or vacated parking space to maintain a real time inventory. Information may be gathered from roaming V2V vehicles to augment the inventory. The inventory of the location of an available parking space is communicated to a V2V equipped vehicle to be displayed on a local dynamic map for the convenience of the drive to locate a parking space.

Referring to the drawings, wherein like reference numbers correspond to like or similar components whenever possible throughout the several figures, there is shown a system 100 and method 200 of using vehicle-to-vehicle (V2V) communication and vehicle-to-infrastructure (V2I) communication for inventorying and communicating the availability of a parking space 102 within a parking area 104 of a parking lot 105.

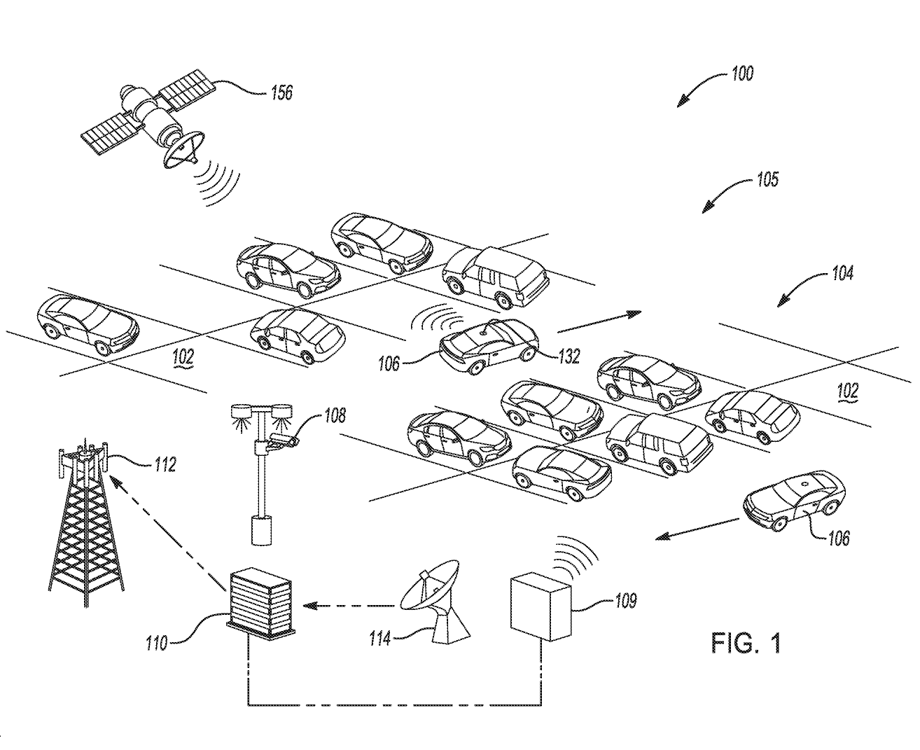

With reference to FIG. 1, the parking area 104 may be that of a portion of the overall parking lot 105; in other words, the parking lot 105 may include multiple parking areas 104. The system 100 includes a V2V equipped vehicle (V2V vehicle) 106 cooperating with infrastructure electronic devices commonly available in commercial parking lots 105 to identify the status of parking spaces 102 as being “occupied” or “non-occupied”, maintain an inventory of the available parking spaces 102, and communicate the status of the parking spaces 102 to V2V vehicles 106 traveling through the parking area 104. Examples of infrastructure electronic devices includes, but are not limited to, monitoring cameras (infrastructure camera 108), computers or processors (infrastructure processor 110), and transceivers (transmitters 112 and receivers 114). These existing infrastructure electronic devices may be modified or upgraded to perform the method 200 as taught in the disclosure that follows.

Electronic monitoring infrastructure cameras 108 are commonly found in most commercial parking lots 105, such as parking lots 105 for shopping malls and airports. These infrastructure cameras 108 are typically mounted overhead on lamp posts or on the exterior sides of building structures. Due to the irregularity of the layout of the parking lot 105, and obstructions caused by buildings, lamp posts, parking lot signs, and other structures, a single or small number of infrastructure cameras 108 may not be adequate to capture the entire parking lot 105. Each infrastructure camera 108 may be limited to capturing an image of a particular parking area 104 of the parking lot 105. The individual images of the particular parking areas 104 may be merged by an infrastructure processor 110 programmed to provide a facsimile of the overall parking lot 105 or as much of the overall parking lot 105 the infrastructure cameras 108 are able to captured. Merging means the compiling and assembling of the individual images into one or more overall images in which overlapping regions are reconciled. The individual images, or the merged image, captured by the infrastructure cameras 108 may be analyzed by the infrastructure processor 110 to ascertain the locations and statuses of the parking spaces 102 as whether “occupied” or “non-occupied”. The locations and statuses of the parking space 102 may be inventoried in an inventory database 107, and the locations of “non-occupied”, or available, parking spaces 102 may be broadcasted or transmitted to V2V vehicles 106 roaming within or adjacent the overall parking lot 105.

The accuracy of the locations and statuses of the parking spaces 102 is dependent on how much of the parking lot 105, or how many parking areas 104, the infrastructure cameras 108 are able to capture and the quality of the images captured. Weather conditions such as rain, ice, snow, and/or fog, contaminants such as dirt buildup on the camera lens, and other factors will have an effect on the effectiveness of the infrastructure camera 108. V2V vehicles 106 may be leveraged to augment and verify the information collected by the infrastructure cameras 108. V2V technology is automobile, or vehicle, technology designed to allow automobiles to communicate with each other and with roadside units (RSU 109) using Dedicated Short-Range Communication (DSRC) devices in the region of the 5.9GHz band with a bandwidth of 75 MHz and approximate range of 1000 m. To a limited extent, WiFi may also be used for V2V communications.

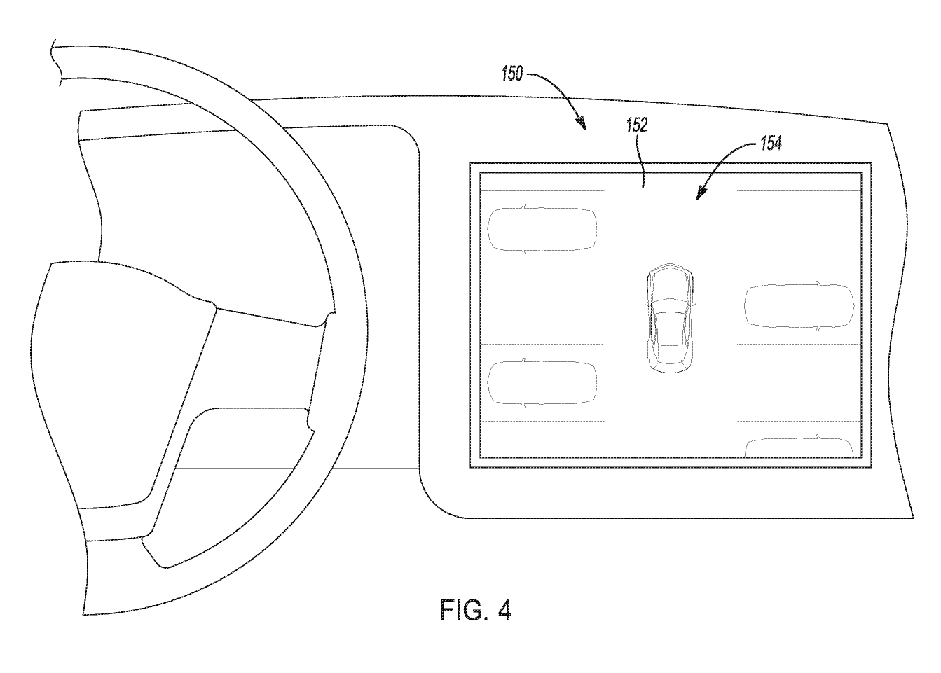

A V2V vehicle 106 may collect information on the statuses and locations of parking spaces 102 as the V2V vehicle 106 travels down an aisle of the parking area 104 and then transmits the information to the infrastructure processor 110 via the RSU 109 and other V2V vehicles. The V2V vehicle 106 may also receive a data stream containing the locations of available parking spaces 102 from the RSU 109 and/or from another V2V vehicle(s), and displayed the information on a local dynamic map (LDM 154) on a dashboard 150 display 152, as shown in FIG. 4.

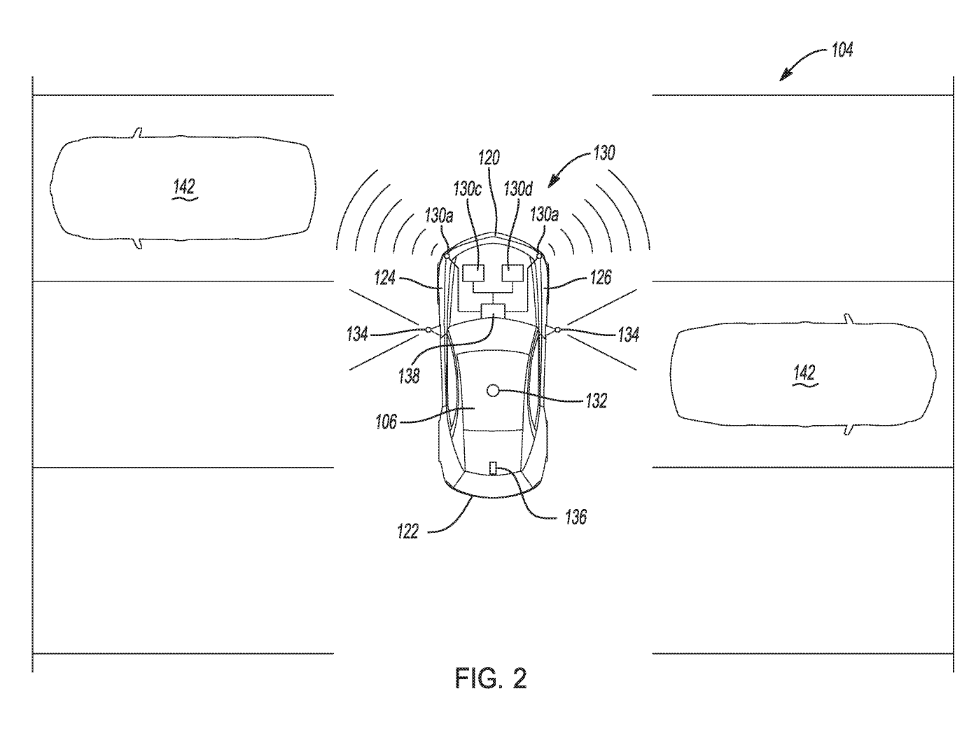

Shown in FIG. 2 is a top view of an exemplary V2V vehicle 106 traveling down an aisle of a parking area 104 having occupied and non-occupied parking spaces 102 on either side of the aisle. Relative to the operator of the V2V vehicle 106, the V2V vehicle 106 includes a front 120, a rear 122, a left side 124, and a right side 126. For illustrative purposes, a passenger type vehicle is shown; however, the V2V vehicle 106 may be that of a truck, sport utility vehicle, van, motor home, or any other type of vehicle without departing from the scope of the present disclosure. The V2V vehicle 106 includes one or more sensors, indicated generally by reference number 130, configured to detect an object 142 in the parking space 102, a vehicle locator 132, a vehicle camera 134, a vehicle transceiver 136, and an onboard processor 138 in communication with the aforementioned devices.

The one or more sensors 130 may operate independently or cooperatively with one another to detect whether an object 142 is within a parking space 102 as the V2V vehicle 106 drives past a parking space 102. A vehicle locator 132 such as a global positioning system (GPS) unit 132 is provided to identifying the location of the V2V vehicle 106 when the V2V vehicle 106 is adjacent the parking space 102 being observed by the sensors 130. The sensors 130 and GPS unit 132 are operative to provide information to the onboard processor 138. The onboard processor 138 assigns a status to the parking space 102 of either “occupied” or “non-occupied”, and assigns a location of the parking space 102 based on the location of the V2V vehicle 106. The onboard processor 138 then sends a vehicle data stream, or signal, containing the status and location of the parking space 102 to the vehicle transceiver 136, which in turn transmits the vehicle data stream to another V2V vehicle and/or RSU 109.

The sensors 130 are in electronic communication with the onboard processor 138 via any wired connection, for example a vehicle bus network. The onboard processor 138 is a non-generalized electronic processor programmed to assigns a status to the parking space 102 of either occupied or non-occupied and assign a location of the parking space 102 based on the location of the V2V vehicle 106 based on information from the sensors 130 and vehicle locator 132, and sends a vehicle data stream containing the status and location of the parking space 102 to the vehicle transceiver 136.

As an example, the sensors 130 may include ultrasonic sensors 130a, 130b mounted on the right 126 and left 124 sides of the V2V vehicle 106, respectively. The ultrasonic sensors 130a, 130b may be oriented in a direction that is substantially perpendicular to the path of the V2V vehicle 106 such that the ultrasonic sensors 130a,130b may detect whether an object 142 is present on the right 126 and left 124 sides of the V2V vehicle 106 as the V2V vehicle 106 travels down the aisle of the parking area 104. The status of a parking space 102 may be determined by the length of time the ultrasonic waves are reflected back to the V2V vehicle 106. The relatively shorter the response time, the more likely the parking space 102 is occupied.

Alternatively, or in conjunction with the ultrasonic sensors, the sensors 130 may include a Light Detection and Ranging (LiDAR) sensors 130c mounted near the front 120 of the V2V vehicle 106. A scanning laser 130d may be used to scan the path of travel of the V2V vehicle 106 as well as the extended peripheral edges of the aisle into the parking spaces 102 on the right and left of the path of travel of the V2V vehicle 106. The scanning laser 130d is used to detect an object 142 in the parking space 102 by illuminating a surface of the object 142 or a reflective target 142, such as that of the reflective tail lamps or license plate of the object 142.

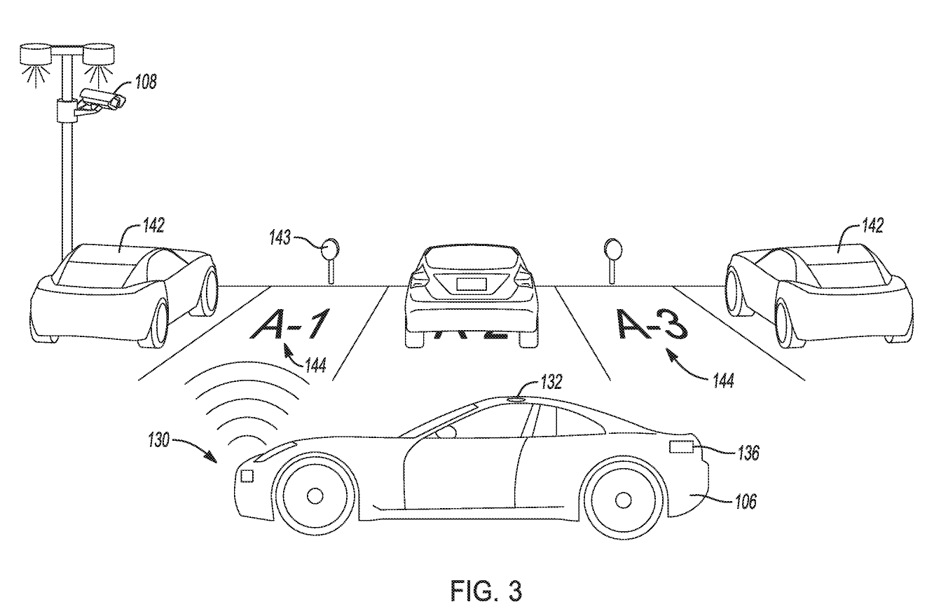

In another alternative, the side mounted vehicle cameras 134 may be used alone or conjunction with the other sensors 130a, 130b, 130c to detect objects 142 in the parking spaces 102. The image captured by the vehicle camera 134 may be compared with an image of a predetermined pattern to determine whether the parking space 102 is occupied. For example, a predetermined pattern, such as a letter or a number, may be mounted on a reflective vertical structure 143, such as a post or sign, adjacent the front the parking space 102 as shown in FIG. 3, such that if the parking space 102 is occupied, the predetermined pattern will be partially or fully obscured when viewed from the aisle way. If the vehicle camera 134 detects the pattern, the onboard processor 138 would assign a status of “non-occupied”. If the vehicle camera 134 does not detect the pattern, the onboard processor 138 would assign a status of “occupied”.

The V2V vehicle 106 includes a communication device 136 communicatively coupled to the onboard processor 138. The communication device generally includes a transceiver 136 having circuitry configured to provide V2V and/or V2I communications. The communication device 136 may be configured to communicate using DSRC protocol and/or Wi-Fi. The communication device 136 may be configured to receive/transmit global navigation satellite 156 information or to receive/transmit high definition (HD) map data stored in memory or from a GPS unit 132. Examples of HD map data may include the map of the parking area 104 showing the individual parking spaces 102.

The V2V vehicle 106 communicates with a RSU 109 that is in communication with the infrastructure processor 110, which is in communication with at least one infrastructure camera 108. The infrastructure processor 110 may be in communication with multiple infrastructure cameras 108 mounted in various locations within the parking lot 105 to capture images of multiple parking areas 104. The infrastructure processor 110 is a non-generalized electronic processor programmed to merge multiple images into a single image, analyze the image to determine whether a parking space 102 is occupied or non-occupied, and determine the location of the parking space 102 based on map or satellite data of the parking area 104.

A reflective marking 144 having a predetermined pattern or outline may be painted or printed within the parking space 102. The marking 144 may be that of a number and/or a letter 144 which corresponds to a location on a map of the parking area 104 in a database or memory. The infrastructure processor 110 may analyze an image of the parking area 104 to determine whether the marking 144 is partially or completely obscured, which would be an indication of the parking space 102 being occupied. Alternatively, the infrastructure processor 110 may be programmed to recognize a general pattern such as the silhouette 146 of a general vehicle viewed from above. If the infrastructure camera 108 detects such a silhouette 146 in the parking space 102, the infrastructure processor 110 would assign the status of “occupied” to the parking space 102.

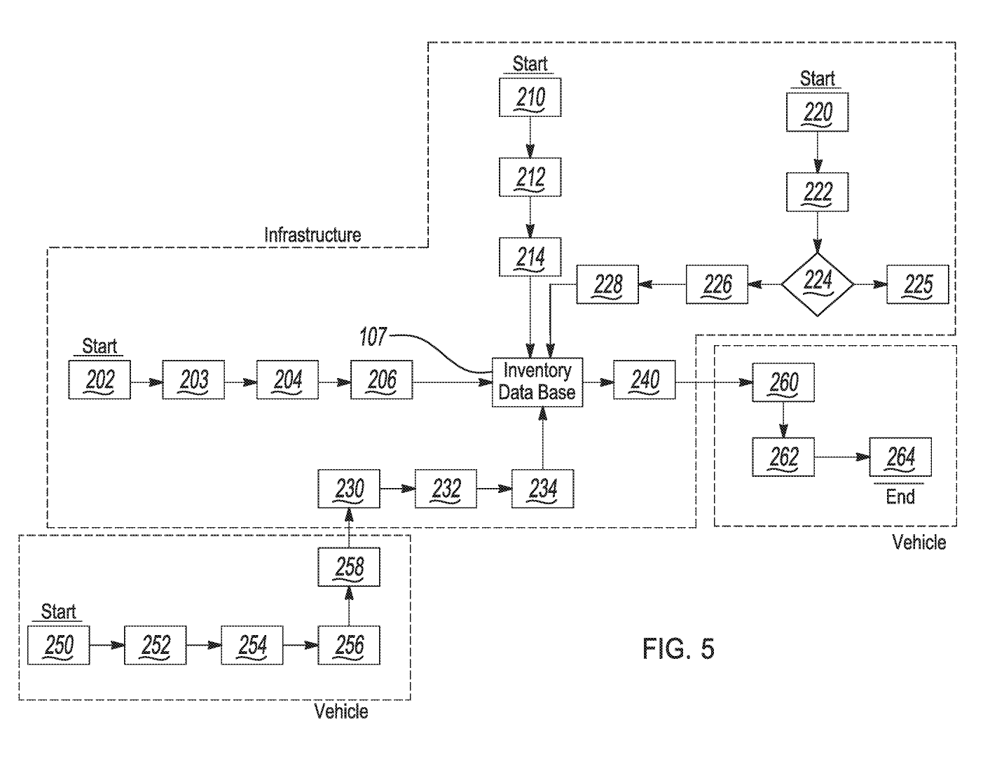

Shown in FIG. 5 is a general flowchart illustrating the method 200 of using vehicle-to-vehicle (V2V) communication and vehicle-to-infrastructure (V2I) communication for inventorying and communicating the availability of a parking space 102.

Starting at step 202, the infrastructure camera 108 captures an image of the parking area 104 having at least one parking space 102, within the larger parking lot 105. At step 203, the image is analyzed by an infrastructure processor 110 to identify whether the parking space 102 is occupied or non-occupied. At step 204 a status of “occupied” or “non-occupied” and a location is assigned to the parking space 102. At step 206, the status and location of the parking space 102 is inventoried in the inventory database 107. Images of multiple parking areas 104 using multiple infrastructure cameras 108 may be captured and merged into one image to capture as much of the overall parking lot 105 as possible.

Starting at step 210, the infrastructure camera 108 captures the real time movement of a parked vehicle vacating the parking space 102 having a status of “occupied”. At step 212, a status of “non-occupied” is assigned to the parking space 102 once the parked vehicle vacated the parking space 102. At step 214, the location and status of the parking space 102 is updated as “non-occupied” in the inventory database 107.

Starting at step 220, the infrastructure camera 108 captures the real time movement of a roaming vehicle entering the parking space 102 having a status of “non-occupied”. At step 222, the infrastructure processor 110 measures the length of time after the roaming vehicle entered the parking space 102. At step 224, if the roaming vehicle continues roaming before a predetermined length of time has elapsed, then the method 200 proceeds to step 225 where the status of the parking space 102 as “non-occupied” is maintained. The predetermined length of time may be that of the amount of time sufficient for a driver to park and exit the roaming vehicle, for example, approximately 5 to 10 mins. At step 224, if the roaming vehicle remains stationary after the predetermined length of time has elapsed, then the method 200 proceeds to step 226 where an updated status of “occupied” is assigned to the parking space 102. At step 228, the location and status of the parking space 102 is updated as “occupied” in the inventory database 107.

The inventory database 107 may be augmented by information collected by one or more V2V vehicle 102 roaming the parking areas 104. At step 230, the RSU 109 may receive multiple data streams from one or more V2V vehicles 106 roaming in the parking lot 105 from step 258, which will be described in detail below. The data streams may include the locations and statutes of parking spaces 102 observed by the V2V vehicle 106. At step 232, the infrastructure processor 110 merges consolidate the locations and statues of the parking spaces 102. At step 234, the locations and status of the parking spaces 102 are updated in the inventory database 107.

At step 240, the RSU 109 sends, or broadcast, an updated infrastructure data stream containing the updated locations and statuses of available, or non-occupied, parking spaces 102 as identified in the inventory database 107 to a V2V vehicle 106 roaming the parking area 104. The infrastructure data stream may contain mapping data sufficient for the V2V vehicle 106 to display a local dynamic map (LDM). Multiple RSUs 109 may be positioned throughout the parking area 104 to provide connectivity support to multiple V2V vehicles traveling within the parking area 104. RSUs 109 may also be provided outside of the parking area 104 to provide connectivity support to V2V vehicles 106 seeking a parking space 102 before entering the parking area 104.

Starting at step 250, as a V2V vehicle 106 drives past a parking space 102, the V2V vehicle 106 detects whether an object is within a parking space 102. At step 252, a status of either “occupied” or “non-occupied” is assigned to the parking space 102. At step 254, the location of the V2V vehicle 106 is determined when the V2V vehicle 106 is adjacent the parking space 102. At step 256, based on the location of the V2V vehicle 106, a location is assigned for the parking space 102. At step 258 a vehicle data stream is transmitted containing the status and location of the parking space 102. This vehicle data stream may be received by other V2V vehicles in the vicinity and/or by the infrastructure processor 110 via the RSU 109 in step 230 above.

At step 260, the V2V vehicle 106 may receive multiple incoming data streams, or signals, containing the status and location of another parking space 102. The multiple incoming data streams may be transmitted from another V2V vehicle traveling in the near vicinity and the infrastructure data stream may from an RSU 109 from step 240 above. The incoming data streams may contain multiple locations of non-occupied parking spaces 102 in overlapping parking areas 104. At step 262, the vehicle on-board processor 138 merges the overlapping portions of the parking area 104 to generate a local dynamic map (LDM) displaying the locations of non-occupied, or available, parking spaces 102 contained in the multiple incoming data streams. In step 264, the V2V vehicle 106 displays a local dynamic map of the parking area 104 showing the merged statuses and locations of the parking spaces 102, and the current location of the V2V vehicle 106 within the parking area 104.

The system 100 and method 200 disclosed herein provides the advantages of increased accuracy in predicting the availability of a parking space 102 and identifying the number and locations of available parking spaces 102, ability to provide real time inventory of parking spaces 102, and communicating the locations of available parking spaces 102 by leveraging and/or minimally modifying commonly available devices.

The description of the invention is merely exemplary in nature and variations that do not depart from the gist of the invention are intended to be within the scope of the invention. Such variations are not to be regarded as a departure from the spirit and scope of the invention. While some examples and embodiments for carrying out the claimed invention have been described in detail, various alternative designs and embodiments exist for practicing the invention defined in the appended claims.

The following is claimed:

1. A method of using a V2V communication system on a vehicle for communicating availability of a parking space within a parking area, includes the steps of:
detecting, using a sensor on the vehicle, whether an object is within a parking space as the vehicle drives past the parking space;
assigning, using a processor on the vehicle, a status to the parking space of either occupied or non-occupied;
determining, using a position locator on the vehicle, the location of the vehicle when the vehicle is adjacent the parking space;
assigning, using the processor, a location of the parking space based on the location of the vehicle; and
transmitting, using a transmitter on the vehicle, a vehicle data stream containing the status and location of the parking space.

2. The method of claim 1, further includes the steps of:
receiving, using a receiver on the vehicle, an incoming data stream containing the status and location of another parking space.

3. The method of claim 2, further includes the steps of:
merging, using the processor, the statuses and locations of parking spaces contained in the vehicle data stream and the incoming data stream; and
displaying, using a display screen in the vehicle, a local dynamic map of the parking area showing the merged statuses and locations of the parking spaces, and the current location of the vehicle within the parking area.

4. The method of claim 2, wherein the incoming data stream is transmitted from another vehicle within the parking area.

5. The method of claim 2, wherein the incoming data stream is transmitted from a roadside unit.

6. The method of claim 5, further includes the steps of:
capturing, using an infrastructure camera, an image of a portion of the parking area;
assigning, using an infrastructure processor, a status and a location for each of the parking spaces within the portion of the parking lot based on the image from the camera; and
sending an infrastructure data stream, using the road side unit, containing the status and location for each of the parking spaces within the portion of the parking lot.

7. The method of claim 6, further includes the steps of:
capturing, using the infrastructure camera, the real time movement of a roaming vehicle moving into a parking space having the status of non-occupied; and
measuring, using the infrastructure processor, the length of time the roaming vehicle remains in the parking space based on the real time movement of the roaming vehicle, and
i. maintaining the status of the parking space as non-occupied if the roaming vehicle continues roaming before a predetermined length of time has elapsed, or
ii. assigning a status to the parking space as occupied if the roaming vehicle remains stationary at or after the predetermined length of time has elapsed.

8. The method of claim 7, wherein the camera continues tracking the roaming vehicle if the vehicle leaves the parking space before the predetermined length time has elapsed.

9. The method of claim 6, further includes the steps of:
capturing, using the infrastructure camera, the real time movement of a vehicle vacating a parking space having the status of occupied; and
assigning, using the infrastructure processor, a status of non-occupied to the parking space once the vehicle vacated the parking space.

10. The method of claim 6, further includes the steps of:
receiving, by the infrastructure processor, multiple data streams containing statuses and locations of parking spaces;
merging, by the infrastructure processor, the statuses and locations of parking spaces contained in the multiple data streams; and
transmitting, by the road side unit, a merged data stream containing the merged statuses and locations of parking spaces;
wherein sources of the multiple data stream are transmitted from multiple vehicles.

11. A method of using V2V communication to inventory and communicate an available parking space within a parking area, includes:
capturing an image of a parking area having at least one parking space;
analyzing the image to identify whether a parking space is occupied or non-occupied;
assigning a location to a non-occupied parking space;
inventorying the location of the non-occupied parking space in a database;
transmitting a signal containing the location of the non-occupied parking space;
receiving the signal by a V2V equipped vehicle; and
processing the signal by the V2V equipped vehicle to display a local dynamic map showing the location of the non-occupied parking space.

12. The method of claim 11, further includes:
detecting, by the V2V vehicle, a non-occupied parking space as the V2V vehicle drives past the non-occupied parking space;
transmitting a data signal, by the V2V vehicle, containing the location of the non-occupied parking space to an infrastructure processor; and
updating, by the infrastructure processor, the inventory of non-occupied parking space in said database.

13. The method of claim 12, further includes:
transmitting a vehicle data signal, by the V2V vehicle, containing the location of non-occupied parking space to other V2V vehicles within the parking area.

14. The method of claim 13, further includes:
receiving multiple signals, by the V2V vehicle, containing locations of multiple non-occupied parking spaces in overlapping portions of the parking area;
merging, by a processor on board the V2V vehicle, overlapping portions of the parking area to generate a local dynamic map displaying the total locations of non-occupied parking spaces contained in the multiple signals.

15. The method of claim 14, further includes:
capturing the real time movement of a vehicle vacating an occupied parking space; and
assigning a status to the parking space as non-occupied once the vehicle vacated the occupied parking space.

16. The method of claim 15, further includes:
measuring the length of time after a roaming vehicle entered a parking space having the status of non-occupied; and
maintaining, using the infrastructure processor, the status of the parking space as non-occupied if the roaming vehicle continues roaming before a predetermined length of time has elapsed, or
assigning, using the infrastructure processor, a status to the parking space as occupied if the roaming vehicle remains stationary after the predetermined length of time has elapsed.

17. A system for inventorying and communicating available parking spaces, includes:
a sensor on a V2V vehicle configured to detect whether an object is within a parking space as the vehicle drives past the parking space;
a vehicle locator for identifying the location of the vehicle when the vehicle is adjacent the parking space;
a processor configured to assign a status to the parking space of either occupied or non-occupied, and assign a location of the parking space based on the location of the vehicle, and
a transmitter for transmitting a vehicle data stream containing the status and location of the parking space.

18. The system of claim 17 further includes:
a camera configured to capture an image of a parking area having a parking space;
an infrastructure processor configured to analyze the overhead image and assign a status to the parking space as either occupied or non-occupied based on the analysis of the overhead image;
a data base configured to inventory the location and status of the parking space; and
a road side transmitter configured to transmitting an infrastructure signal containing the status and location of the parking space to the V2V vehicle.

19. The system of claim 18, wherein the infrastructure processor is further configured to send an infrastructure signal to display a local dynamic map (LDM) showing the location and status of the parking space within the parking area.

20. The system of claim 19, further includes:
an infrastructure receiver configured to receive multiple vehicle data streams containing locations and statuses of parking spaces from multiple V2V vehicle;
wherein the infrastructure processor is further configured to merge the information contained in the multiple vehicle data streams to remove overlapping information.
